(19) United States
(12) Patent Application Publication
(10) Pub. No.: US 2024/0029074 A1
(43) Pub. Date: Jan. 25, 2024

(54) OFFER CREATION

(71) Applicant: EquiDeFi Ltd., Fort Lauderdale, FL (US)

(72) Inventors: Harvey KESNER, Fort Lauderdale, FL (US); Mohit BHANSALI, New York, NY (US)

(21) Appl. No.: 18/223,781

(22) Filed: Jul. 19, 2023

Related U.S. Application Data
(60) Provisional application No. 63/390,511, filed on Jul. 19, 2022.

(51) Int. Cl. G06Q 20/40; G06Q 20/02; G06Q 20/38; G06Q 20/36

(52) U.S. Cl. CPC G06Q 20/405; G06Q 20/02; G06Q 20/3825; G06Q 20/367; G06Q 2220/00

(57) ABSTRACT

Utilizing tools that apply regulatory rules to financial instruments such as private offerings of securities via a rules-based architecture for documentation and funds-flow, design and communications, for example, a user, such as an offeror of a financial instrument (securities), may select a standard of compliance appropriate to the offering based on desired jurisdictions. The selection may initiate a workflow to create compliant documents for the offering using a web-based user interface to walk users through one or more of: (1) generation of the offering documents, (2) collection of the conditions precedent for each workflow, and (3) the closing and transfer of funds, including funds that are crypto, CeFi and DeFi, such as stablecoins, Ethereum, Bitcoin and the like, used for the purchase price of the investment. Thereafter, a compliant workflow for the intermediation of transactions which involve 1-3 above but for subsequent transfers of the financial instruments (securities) among subsequent buyers and sellers (aftermarket).

### CROSS-REFERENCE TO RELATED APPLICATION

This application claims the benefit of U.S. Provisional Application No. 63/390,511, filed Jul. 19, 2022, and titled “OFFER CREATION,” which is herein incorporated by reference in its entirety.

### BACKGROUND

Regulatory requirements surrounding newly emergent “crypto” technologies for finance have largely evaded critical analysis. In the field of cryptocurrencies (crypto), initial coin offerings (ICOs), tokenization, alternative trading systems (ATS), and decentralized finance (DeFi) rely upon a blockchain registry which records activities “in the cloud”. Similarly, secondary (resale) transactions utilize blockchain to record changes of ownership of assets. Whether and when these articles are the equivalent of traditional securities and asset transactions, as well as their subsequent transfer, was for an extended period, ambiguous. Increasingly, legal proceedings in court and pronouncements from regulators in both digital and non-digital assets point to the need for verification steps (which we can also refer to as proof of truth).

### SUMMARY

Disclosed herein are tools that apply regulatory rules to financial instruments including crypto, CeFi (centralized finance), and DeFi offerings, for example. As used herein, a financial instrument may be considered a contract that holds monetary value, such as (and without limitation) stocks, bonds, certain insurance contracts, cryptocurrency (including stablecoins), and/or smart contracts/sets of smart contracts that represent cryptocurrency and other assets.

In some embodiments, a user, such as an offeror of a financial instrument, may select a standard of compliance appropriate to the offering (e.g., an Initial Public Offering (IPO), Special Purpose Acquisition Company (SPAC), Registered Direct Offering, or Private Placement) based on desired jurisdictions. The selection may generate a workflow to create compliant documents for the offering using a web-based user interface to walk users through one or more of: (1) generation of the offering documents, (2) collection of the conditions precedent for each workflow, and (3) the closing and transfer of funds, and subsequently, the movement of the financial instrument among subsequent owners of the financial instrument whilst (1) documenting and recording on an official registry the transfer, (2) notifying the issuer of the transfer, and/or (3) closing and transfer of funds.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which the technology described herein may be employed.

FIG. 2 illustrates an example user workstation arranged according to at least one embodiment.

FIG. 3 illustrates an example web server that may be utilized to provide the web application to the user workstation.

FIG. 4 illustrates an example of digital financial system elements that are stored on or accessible by the objects of the offer using respective workstations.

FIG. 5 is an example user interface that presents a workflow implemented by the web application for the user to create an offer for a financial instrument.

FIG. 6 is an example user interface that presents a screen of the workflow subsequent to the screen in accordance with selection of the radio button.

### DETAILED DESCRIPTION

Regulations have failed to articulate what methods or processes would be acceptable to discern when compliance with regulatory requirements is present or can be certified, at the level of confidence of existing practices which are predominantly paper based or in person. Verification steps may rely on manual processes with the likes of ink signatures, pdf or faxed documentation, emails and/or manual funding via check or wires. These are the antithesis of modern commerce. Online brokerages, trading clearance and settlement have long taken hold of digital and cloud-based verification, client onboarding, disclosures, and customer contracts. The actual transactions between counterparties in such settings takes place via the medium of a stock exchange or trading platform curated by the brokerages which one another. But in the realm of private offerings, the unique investor must transact directly with an issuer of securities and does not utilize any intermediation of purchase and sale conventions. Both digital and non-digital “private” offerings of securities require numerous distinct steps unique to those workflows including (A) solicitation. (B) verification, (C) contract execution, (D) funding and (E) closing. After closing, documentation has to remain available to process trades and transfers in order to prove the offering complied with law. The digital assets are subject to the very same (or similar) regulatory regimes fraught with risk and errors that can put the validity of the offering at risk and impede or prevent subsequent transfer or sale.

A method is therefore needed for online or digital, “in the cloud” secure processes to achieve steps (A)-(E), which also reduces friction, allows for instantaneous recordkeeping and secure storage of documents, contracts and agreements, provides the ability to collect, search and query data and/or perform statistical analysis and identity verification across all platforms, both for digital and non-digital, akin to paper-based systems. Through such processes embedded online software or blockchain-based smart contracts provide confirmation for regulators and others, often months or years later, to verify that appropriate steps have been taken (without in person, manual or paper) in the digital realm with identity verification and an audit trail to satisfy legal requirements and allow issuers of securities and investors alike to confirm their activities pass regulatory muster.

With the recent onslaught of legal and regulatory activity against founders, organizers, promotors, DAOs and non-profit sponsors of tokens and crypto offerings, their investors and those who have benefitted financially or through illegal means, regulatorily compliant software solutions are needed. Commerce in general has become increasingly speedy and anonymous (digital and non-digital) where fiat currency, Bitcoin. Ethereum and the like are converted or used to purchase other assets. Identifying characteristics of a purchaser/investor may merely be an IP or wallet address. Testing if such purchaser/investor, in fact, satisfies regulatory requirements wherein identification may only occur via an IP or centralized/decentralized wallet address (such as Coinbase or Metamask) abhor traditional channels (paper, pdf, scans and facsimiles) which creates difficulties in procuring information that prove compliance with regulatory pathways. Additionally, the relatively instantaneous speed with which transactions and payments occur on a blockchain are not suited to such information testing or procurement which historically involved human intervention by lawyers or compliance personnel. Neither can modem transaction methods readily prove required regulatory compliant “holding” periods before subsequent transfers of assets are permissible. In the case of crypto and blockchain based interactions, an IP address is also not readily associated with a person wherein processes to satisfy regulations developed long before the advent of online and blockchain technologies are needed. Securing investor/purchaser testing “if” a person (purchaser or investor) associated with an investment satisfies all legal requirements and a way to impose on purchasers/investors (via escrow accounts, smart contracts or stop transfer orders) to allow a “hold” of the crypto/digital assets/securities for the requisite holding periods to evidence legal criteria for “investment intent” are also needed.

As an extra problem, many startups do not have banking or regulatory experts. Yet these startups are responsible for creating a set of documents that are regulatory compliant. In addition, as described herein, in some instances it is required or at least desirable to ensure that potential investors are “accredited.” or “qualified” meaning that they meet standards that are associated with investor suitability for the type of financial instrument being offered. For example, certain high-risk offerings may be restricted to high-net-worth investors, others may be available only to United States citizens, and in such instances the workflow may prompt the offeror to enter information that causes the offer to indicate and be limited to such accredited investors.

Furthermore, current private placement practices, whether directed towards traditional asset classes such as common stock, preferred stock, convertible notes, warrants, options or rights, are dominated by paper documentation, manual signatures, PDF scans, emails, and faxes. Funding often requires a physical visit to the bank. Documents are sent via email, signatures are obtained via PDF and emailed or faxed back, investors must visit their banks to send wires, and/or records are routinely lost or misplaced causing lost market opportunities, executive inattention, and costly legal advice. Months later when SEC rules permit, moving securities from a paper-based record system or “book-entry” to a brokerage account through the Depository Trust Company (DTC), a required step, can take weeks and can cost thousands of dollars for legal opinions, broker review and wasted time.

Accordingly, a software tool that automates the process of collecting documentation equally applicable to crypto, blockchain and/or traditional asset classes of securities that performs in a manner that removes roadblocks to effectuating offerings and their progeny, while creating workflows that enable the creation of regulatory compliant offer documents and/or processes that facilitate proofs of truth in cataloguing, managing and/or processing subsequent document and electronic equivalents, is highly desirable.

This disclosure describes techniques for providing issuers with simple tools to connect with individuals and other private placement investors and improve their capital raising, and straightforward resources for investors to monetize and manage their investments.

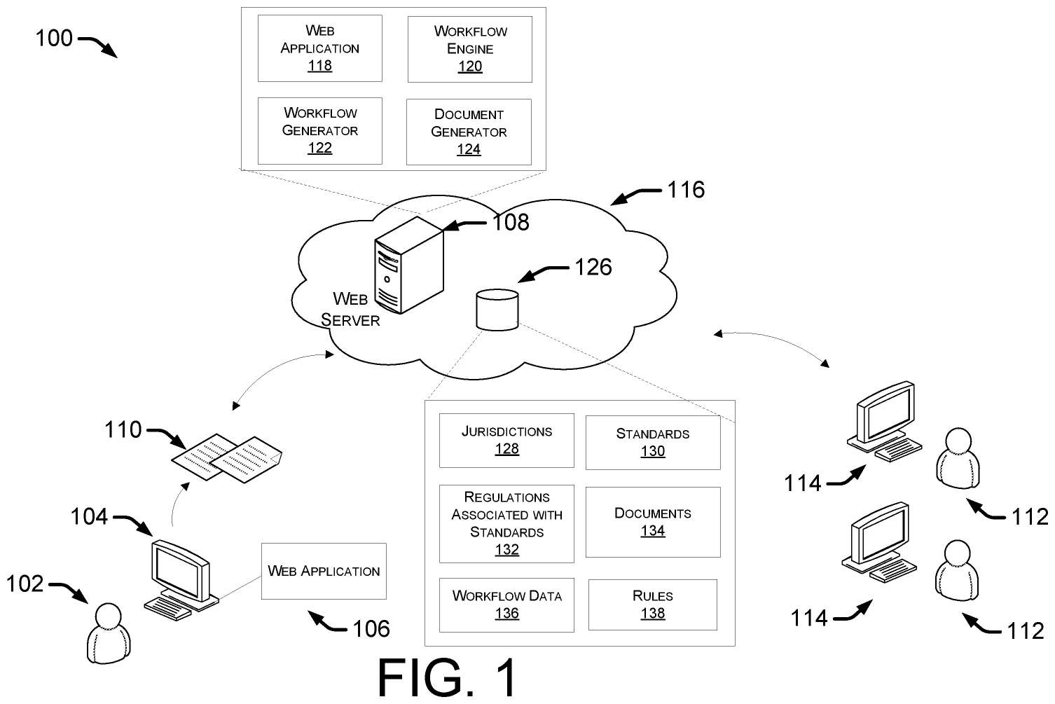

FIG. 1 illustrates an example architecture 100 in which the technology described herein may be employed. As shown in FIG. 1, a user 102 using a computing device 104 may create an offering of a financial instrument by using a web application 106 resident on the computing device 104. In some embodiments, the web application 106 may be configured to interact with a web server 108 to create the offering. Information entered into the web application 106 may be compiled to automatically create one or more documents 110 required for the offering in a manner that is regulatory-compliant, incorporating certain rules that the software will require the users conform to in order to proceed through the workflow. In some embodiments, the information supplied by the user 102 may be on or entered on a blockchain. In some embodiments, the financial aspects (payment for the financial instrument) may be via linkages of bank, brokerage, CeFi, DeFi or other accounts where value is stored, in order to pass value for the purchase of the financial instrument to the user (issuers) or back to other users, for example, by linking a stablecoin wallet of a user to the wallet controlled by or used by the software to intermediate the transaction commerce and apply software rules for compliance in order to satisfy regulatory requirements, or in other cases to transmit the value to the issuer of the securities being purchased by the user, or in the inverse—to return value or funds to users when the software or other users determine that rules for the transaction do not permit the transaction. In other embodiments, the financial aspects will utilized wires, automated clearing house funds transfers (ACH), check or cash which would similarly be intermediated by the software for transaction commerce and apply the software rules to the transaction. The created documents 110 may be uploaded individually or en masse to the web server 108, obviating the need for manual creation, printing, signature, scanning, emailing or otherwise submitting for review/approval, and/or myriad other actions commonly required.

One or more objects 112 of the offering (typically investors, brokers, and/or agents; hereinafter “investors”) may access information about the offering via one or more computing devices 114. Communications among one or more of these components may be accomplished via one or more networks such as, without limitation, the Internet, virtual private network(s), wireless carrier network(s), wide area network(s), local area network(s), and/or the like, represented by a network 116. In some embodiments, the network 116 may include a cloud network and the web server 108 may be partially or entirely distributed in the cloud network, or a tablet, video display or smartphone, for example via an Apple IOS, Google, Android or other mobile app.

The web server 108 may have or have access to a web application 118, a workflow engine 120, a workflow generator 122, and a document generator 124. The web application 118 includes executable software that is configured to interface with the web application 106 of the user workstation 102 to provide a wizard driven by the workflow engine 120. The workflow engine 120 includes software that is configured to provide a menu-driven workflow presented at the user workstation 102. The workflow may be generated by the workflow generator 122 to include user response-driven screens displayable to the user 104 via a user interface on the user workstation 102, drop-down menus and other points of data entry, and other features that walk the user 104 through the offer creation process, keeping the process “on the rails” so that the documents that are ultimately created by the document generator 124 in support of the offer are regulatory-compliant and meet necessities of the offer. The workflow is generated by the workflow generator 122 to enforce rules for creating the offering.

The web server 108 may include or be configured to access a data storage 126. The data storage 126 may contain, for example, one or more databases or other structured storage of regulatory jurisdictions 128, standards 130, and/or regulations 132 associated with the standards 130. Examples of regulatory jurisdictions 128 may include the Securities and Exchange Commission; FINRA, NASDAQ, NYSE, or other stock, commodities, and currency exchanges; state, local, and other federal agencies, etc. Examples of standards 130 may include industry and/or regulatory standards such as Securities Act of 1933, as amended, Securities Exchange Act of 1934, Investment Company Act or 1940, Investment Advisors Act of 1940, rules and regulations of national securities exchanges or OTCMarkets, Inc., state and local regulations, federal and state banking and insurance regulations, ISO, PCI DSS, CCSSS, and the like. Examples of regulations 132 associated with the standards 130 may include CCPA, NYCRR, and the like. Jurisdictions, standards, and regulations are not limited to the United States.

The data storage 126 may also contain documents 134 created by or for the workflow, workflow data 136 entered by the user 102 at the user workstation 104 or retrieved from another source, and/or rules 138 enforced by the workflow generator 122 and/or workflow engine 120 as part of creating a regulatory-compliant and investor-approvable offer. The documents 134 and/or workflow data 136 may be saved during offer creation, for example in the event that the workflow is interrupted or the user 102 wishes to pause the workflow until a later time or end it altogether. In some embodiments, the document creation may be directed by the user 102 as guided by the workflow engine 120 but in fact occur at the client workstation 104 using the workflow data 136 to create the documents 134. Additionally, or alternatively, the documents 134 and/or workflow data 136 may be saved for recordkeeping in the event of an audit, for example. The rules 138 may include, without limitation, presentation of specific drop-down menus for user entry or selection that are based on previous input by the user, such as information that refines a previous entry or addresses a regulatory need based on a previous entry.

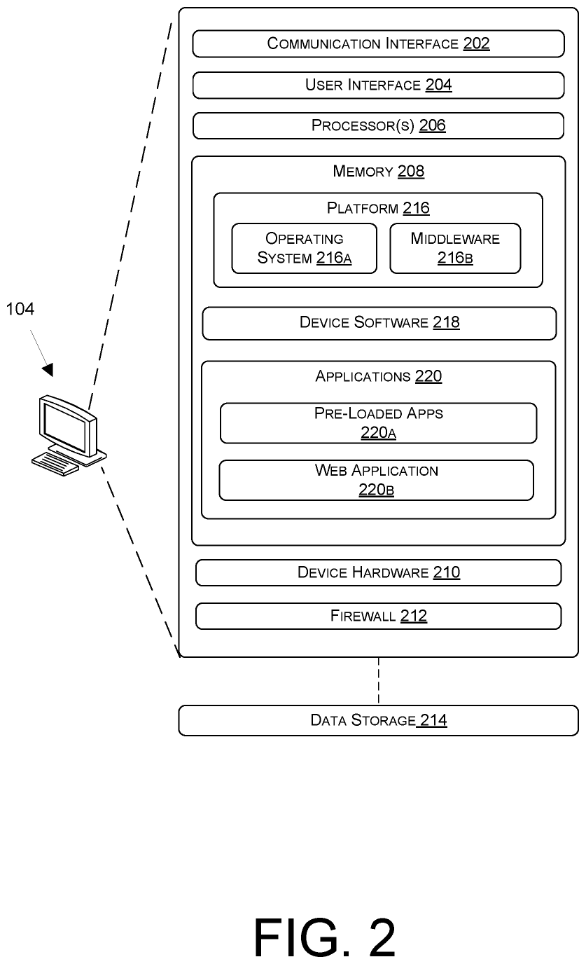

FIG. 2 illustrates an example user workstation 104 arranged according to at least one embodiment. As shown in FIG. 2, the user workstation 104 may include a communication interface 202, a user interface 204, one or more processors 206, memory 208, device hardware 210, and a firewall 212. In some embodiments, the user workstation 104 may be connected for access to a data storage 214.

The communication interface 202 may include wireless and/or wired communication components that enable the electronic device to transmit or receive voice or data communication, e.g., with the web server 108.

The user interface 204 may enable a user 102 to provide input and receive output from the client workstation 104, including for example providing one or more input to request the web application 106 and output the documents 110. The user interface 204 may include a data output device (e.g., visual display, audio speakers), and one or more data input devices. The data input devices may include, but are not limited to, combinations of one or more of touch screens, physical buttons, cameras, fingerprint readers, keypads, keyboards, mouse devices, microphones, speech recognition packages, and any other suitable devices or other electronic/software selection methods.

The one or more processors 206 and the memory 208 may implement a platform 216 including an operating system 216a, device software 218, one or more applications 220. The one or more applications 222 may include various pre-loaded apps 220a, a web application 220b (that may correspond to the web application 106), and/or other apps. In some embodiments, the application(s) 222 may include a workflow engine (not shown) that may correspond to the workflow engine 120. The various software and applications may include routines, program instructions, objects, and/or data structures that perform particular tasks or implement particular abstract data types.

The operating system 216a may include components that enable the user workstation 104 to receive and transmit data via various interfaces (e.g., user controls, communication interface 202, and/or memory input/output devices). The operating system 216a may also process data using the one or more processors 206 to generate outputs based on inputs that are received via the user interface 204. For example, the operating system 216a may provide an execution environment, such as a Java Virtual Machine or Microsoft's Common Language Runtime™, for the execution of the applications 220. The operating system 216a may include a presentation component that presents the output (e.g., displays the data on an electronic display, stores the data in memory, transmits the data to another electronic device, etc.). The operating system 216a may include an interface layer that enables applications to interface with the communication interface 202. The interface layer may comprise public APIs, private APIs, or a combination of both public APIs and private APIs. Additionally, the operating system 216a may include other components that perform various other functions generally associated with an operating system.

The device software 218 may include software components that enable the user workstation 104 to perform functions. For example, the device software 218 may include a basic input/output system (BIOS), Boot ROM, or a bootloader that boots up the user workstation 104 and executes the operating system 216a following power up of the workstation.

The applications 220 may include applications that provide functionalities to a user of the user workstation 104. For example, the applications 220 may include pre-loaded apps 220a such as telephony applications, electronic mail applications, remote desktop applications, web browser applications, navigation applications, office productivity applications, multimedia streaming applications, and/or so forth. The applications may further include a web application 220b that provides a webpage to enter user information such as the offeror of a financial instrument to create various documents 110 used in creating the offer in a compliant manner.

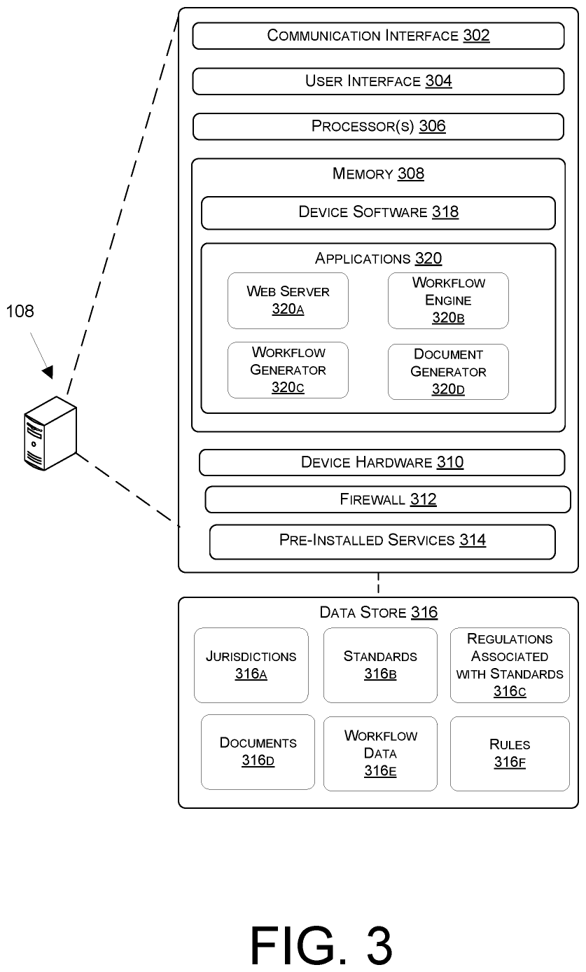

FIG. 3 illustrates an example web server 108 that may be utilized to provide and interact with the web application 220b on the user workstation 104. In some embodiments, the web server 108 may include a communication interface 302, a user interface 304, one or more processors 306, memory 308, device hardware 310, a firewall 312, and pre-installed services 314. In some embodiments, the web server 108 may include or be connected for access to a data storage 316.

The communication interface 302, user interface 304, processor(s) 306, memory 308, device hardware 310, and firewall 312 may be configured and function in a manner similar to the corresponding components of the user workstation 104.

The memory 308 may store device software that contains executable instructions to perform operations to implement the web server 108. The memory 308 may also store applications 320 that include one or more of a web application 320a, a workflow engine 320b, a workflow generator 320c, and a document generator 320d. In some embodiments, the web application 320a corresponds to the web application 118, the workflow engine 320b corresponds to the workflow engine 120, the workflow generator 320c corresponds to the workflow generator 122, and the document generator 320d corresponds to the document generator 124.

In some embodiments, the data store 316 may store, for example, one or more databases or other structured storage of regulatory jurisdictions 316a (which may correspond to the jurisdictions 128), standards 316b (which may correspond to the standards 130), regulations 316c (which may correspond to the regulations 132) associated with the standards 316b, documents 316d (which may correspond to the documents 134), workflow data 316e (which may correspond to the workflow data 136) and rules 316f (which may correspond to the rules 138).

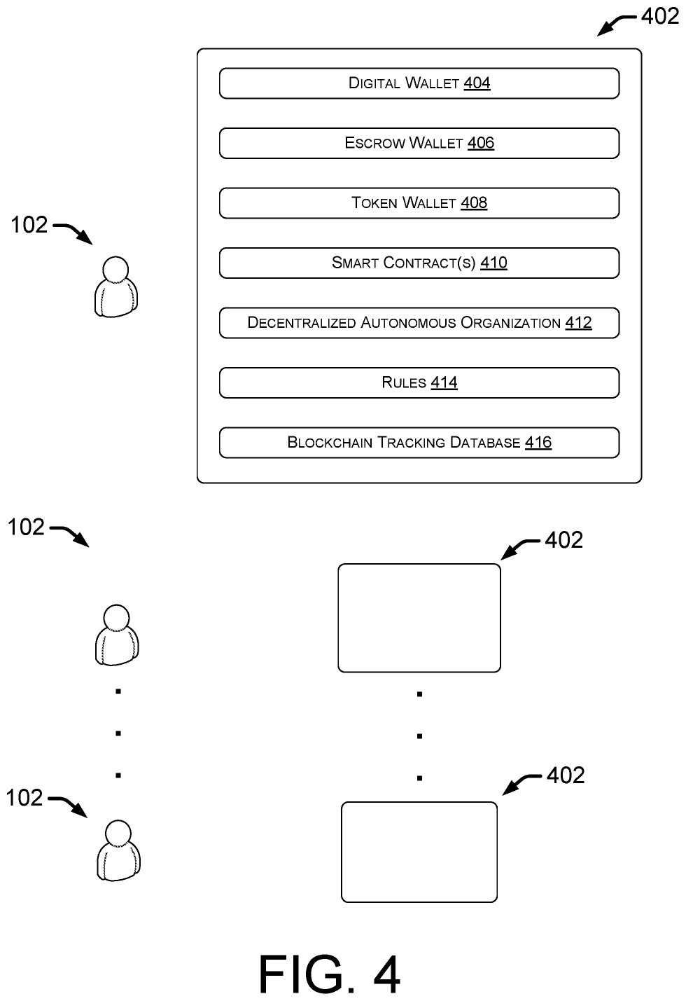

FIG. 4 illustrates an example of digital financial system elements 402 that are stored on or accessible by the objects 112 of the offer using respective workstations 114. In some embodiments, the digital financial system elements 402 may include a digital wallet 404 for digital assets such as cryptocurrency, an escrow wallet 406 for digital assets held in escrow to back a financial transaction, a token wallet 408, one or more smart contracts 410, a decentralized autonomous organization (DAO) 412, rules 414, and/or a blockchain tracking database 416 for the data being passed between the web server 108 and the objects 112.

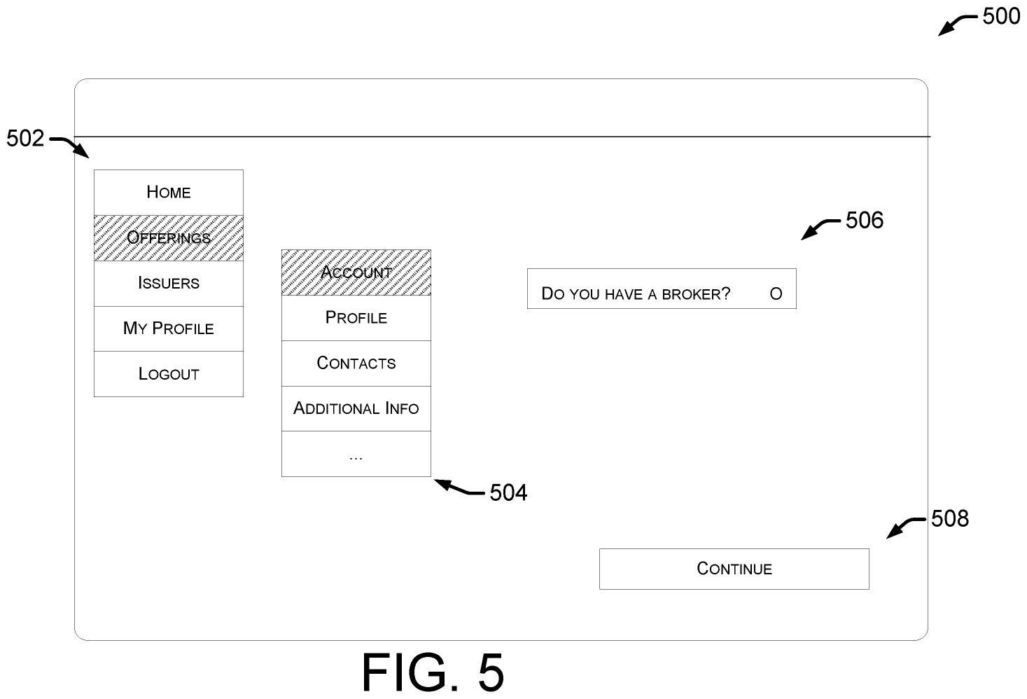

FIG. 5 is an example user interface 500 that presents a workflow implemented by the web application 106 for the user 102 to create an offer for a financial instrument. In the example of FIG. 5, the web application 106 may present or cause the presentation on the user workstation 104 of a succession of screens that comprise a wizard for walking the user 102 through the process of creating the offer. In some embodiments, the workflow is created by the workflow engine 120, which implements the rules 138 to drive creation of the documents 110 supporting the offer.

The presentation 500 may include numerous menus, of which a basic menu 502 and a workflow menu 504 are shown. The basic menu 502 may include interactive options such as a “home” button, an “offerings” button, an “issuers” button, and buttons for “my profile” and to “logout”. The workflow menu 504 may appear in accordance with the selection of one of the menu button options. In some embodiments, the buttons presented in the workflow menu 504 may be organized in sets such that a first set is presented in response to selection of the “account” button, a second set in response to the “profile” button, etc. In FIG. 5, an example of selecting “offerings” results in the presentation of button options for creating or reviewing an offering of a financial instrument. The button options for offerings in the example include “account,” “profile,” “contacts,” “additional information,” etc. By way of nonlimiting example, the presentation 500 shows a result of the user 102 selecting “offerings” to create an offering, and “account” to begin the offer creation.

On selecting “account” in the example shown, a new box 506 appears that requests the user 102 to enter an indication of whether the user 102 has a broker. Selection of the radio button associated with the request causes a dropdown menu to appear. Selection of “continue” 508 without selecting the radio button may cause a different response (not shown). For example, the dropdown menu that appears on selecting the radio button may produce a series of boxes or other entry points to enter information concerning the broker, whereas selection of the “continue” button 508 without selecting the radio button may cause the workflow to skip the entry of broker information and proceed to a subsequent stop.

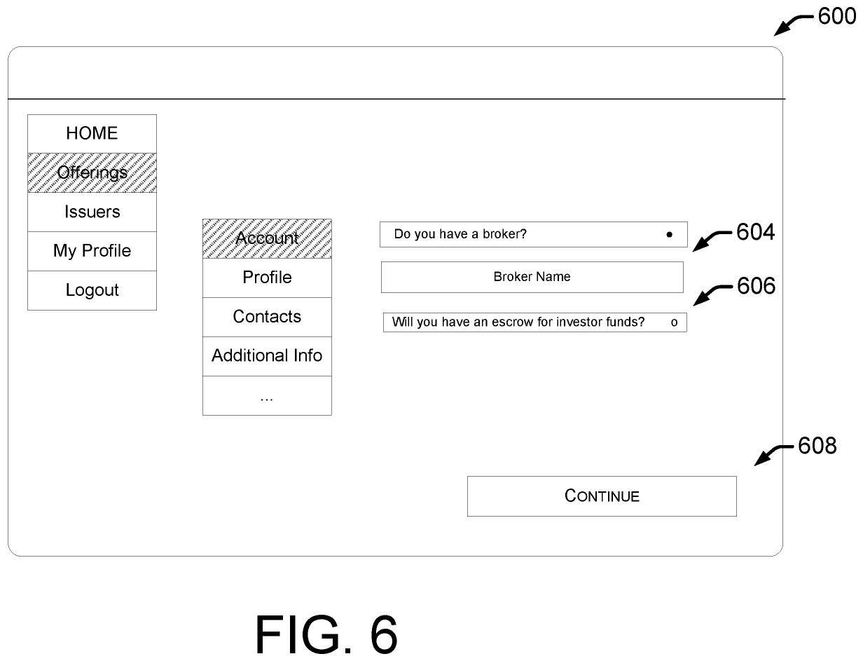

FIG. 6 is an example user interface 600 that presents a screen of the workflow subsequent to the screen 500 in accordance with selection of the radio button. After selection of the radio button, two additional entry boxes 602 and 604 appear. It is emphasized that the nature of the points of data entry, the information requested, the sequence of presentation, etc. are illustrative and limitation should not be inferred. However, the illustration demonstrates the guided nature of the presented stops of the workflow, and in particular illustrate how the workflow presentation keeps the user “on the rails” so that the documents ultimately created to make the offer are properly prepared in compliance with relevant regulations and best practices.

In the example shown in FIG. 6, a box 604 appears that requests the name of the broker indicated by the user's selection of the radio button as depicted. Another box 606 appears that requests the user 102 to indicate whether there will be an escrow for investor funds in connection with the offer. If without blockchain, the escrow may be provided by a third-party service using a traditional database, and the escrow can be effected by having a human being determine when to release items. Where a blockchain is involved, escrow can be implemented using a smart contract on the blockchain that enforces when assets are digitally released, useful if the assets are digital in nature. Alternatively, the smart contract can be triggered by a DAO organization as well. Selection of the corresponding radio button may cause additional information and/or entry points (not shown) to appear, which correspond to the selection. For example, information related to the escrow (e.g., account number, escrow agent) may be entered. On the other hand, non-selection of the radio button, followed by selection of the “continue” button 608 may cause a new screen to be presented, with a corresponding request for information.

Notably, the example(s) described herein are for illustrative purposes only and the workflow is not limited to the specifics in any way. A more complete, again nonlimiting, example continues without benefit of presenting a complete set of screens, for simplicity.

The present example, begun with FIG. 5, guides an offeror of a financial instrument through preparation of the offeror. Following the workflow, including entering all required information, may result in a complete or partially complete creation of documents supporting the offer, fully compliant with applicable regulations and standards for a jurisdiction indicated by the user 102.

In general, entries in the interactive, menu-driven workflow generate subsequent pop-ups, drop-down menus, entry boxes, and/or the like that enforce rules based on the user's prior input(s). That is, in some embodiments, each time or times the user enters requested information, another request appears, and each request calls for information of the type that, if properly entered by the user 102, enables if not ensures that the user will create compliant documents, even if the user is unaware of regulatory requirements or lacks knowledge of the same even if aware.

Subsequent to the information entered in FIG. 6, if the user does not have an escrow but will require the services of an escrow agent, the workflow may initiate the process for an agent to contact the user and provide assistance in setting up an escrow solution. In this way, the technique is both a workflow manager and a way to upsell services.

Once all the escrow agent's bank details have been confirmed, the user may press Continue or the like and will now start the next section/screen to continue entering information for establishing an account (for example, the name of the offering company or asset, ticker symbol (if any), and/or the like). Company contacts may be entered, if any.

In some embodiments, drop-down menus, prompts, or other information requests drive the process of creating the offer according to the workflow enforced by the rules. At some stops, drop-down menus may present a fixed set of options, one of which must be selected to ensure compliance. In other stops, options presented may include options for, e.g., “none,” “other,” or a text entry box for entering arbitrary information. In the latter case, the entry may be informative only and not driven by a regulatory compliance. Ultimately, the workflow ensures that information required for regulatory compliance or best practices will be obtained to create the proper, and properly completed, documents to support a compliant offer. Beginning the workflow by entering the type of offer and jurisdiction, at least, draws the workflow that, guided through dropdown menus and the like, results in the creation of documents that support an offer that is compliant in that jurisdiction.

Continuing with the example, subsequent dropdown menus may offer fixed options (for example, a request for the type of a contact related to the offer (e.g. broker/dealer, corporate counsel) may be required to guarantee that an authorized representative is entered). Entry of the contacts may coincide with certain access permissions such as providing portal access to the system or in-progress offer creation, for example.

In a subsequent screen, it may be requested to define the offering (e.g., the size of the offering). For example, the number of shares, maximum number of shares, % overflows, etc. may be entered. This type of information may satisfy certain SEC transparency requirements, as well as providing an asset manager the ability to manage modifications and changes subsequent to entry.

In another screen, a drop-down menu may provide a list of defined exemptions from which one must be selected. In this example, prohibited exemptions are not presented in the list, so only an exemption valid for the offering may be chosen, and the choice must be made in order to continue. This requires the user to stipulate the proper exemption from the drop-down list, and keeps the offer creation “on the rails” with assurance of regulatory compliance.

Another screen may guide the user through recording requisite dates. This calendar may be used, e.g., to trigger key events such as Launch, Termination, or other milestones. Events that are not met, or actions not completed by the requisite dates, may be notified to appropriate people. This is another example of the workflow forcing the offer creation process to stay on the defined rails. In some embodiments, there may be software mechanisms for shifting dates, sending notifications when dates get moved and optionally requiring responses to those notifications. In a sense, the rails can shift, but following the workflow ensures that the process stays on them regardless.

It is to be noted that the rules- and menu-driven workflow that defines the offering, informs what requirements there are, the nature of the relevant standards, etc. will drive a different workflow based on regulation requirements. The regulation requirements are “baked in” so that the offeror does not even have to know or even be aware of them, as the workflow engine is designed so that an orderly workflow process will guide the offer creation to a successful completion.

In some embodiments, the rules enforced by the workflow engine may be updated based on events (for example, to ensure compliance with new regulations, business logic, etc.). In such embodiments, the workflow is in fact a dynamic workflow. Modifying the rules seamlessly updates the workflow engine to accord with the new requirements, and causes the user to enter information accordingly without needing to be aware of any changes that underlie the workflow modification.

After completing the wizard to the end, documents prepared for the offer may be electronically signed and uploaded as a package. In some instances, the entire, or nearly the entire, set of documents necessary for creating the offer may be generated by simply following the workflow. Eventual integration with a “data room” may permit access by potential investors, where additional documents requested by potential investors may be added, all of which can be provenanced and tracked. This greatly simplifies the offer creation process, eliminating the need for cumbersome emails/faxes/original signatures/countersignatures in both directions, provides provenance for the documents, and ensures that no investor can proceed without the proper compliance-driven documentation.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed is:

1. A method to generate and execute a workflow, the method comprising:
accessing at a workflow generator, a data store, the data store storing rules relating to workflow, jurisdiction data, standards data, and regulations data;
based on at least the accessed rules, generating by the workflow generator a dynamic workflow embodied in a wizard comprised of a succession of screens, the screens implementing rules to drive the creation of documents compliant with the accessed jurisdiction data, standards data, and regulations data, such that a user of the wizard cannot deviate from the underlying workflow.

2. The method of claim 1, comprising:
receiving a change to one or more of the jurisdiction data, standards data, and regulations data; and
responsive to receiving the change, dynamically changing the workflow, and the wizard to reflect the received change.

3. The method of claim 1, comprising:
executing the wizard via the workflow engine, the workflow engine displaying the succession of screens of the wizard on a user interface;
receiving via the user interface, user input; and
sending the received user input to the wizard via the workflow engine.

4. The method of claim 3 wherein the user interface is any one of a web page, or a mobile application.

5. The method of claim 3, comprising:
at the workflow engine, receiving user input to pause the wizard;
responsive to receiving the user input to pause;
determining at the workflow engine whether the workflow is at a stop; and
if the workflow is at a stop, saving the data of the workflow in the data store, such that the workflow engine can restart the wizard with the saved data such that the user can resume the wizard at the stop.

6. The method of claim 3, wherein at least one of the succession of screens embodies logic to access a third party.

7. The method of claim 6, wherein the third party is an escrow service.

8. The method of claim 3, comprising in at least one of the succession of screens, accessing the data store, the data store storing document data, and at the workflow engine generating a document based at least on some user input and the accessed document data.

9. The method of claim 8, wherein at least one of the succession of screens embodies logic to obtain an electronic signature for the generated document.

10. The method of claim 8, wherein at least one of the succession of screens embodies logic to store the generated document in a data room.

11. The method of claim 1, wherein at least one of the succession of screens embodies logic to access information in any one of a digital wallet, escrow wallet, or token wallet.

12. The method of claim 1, wherein at least one of the succession of screens embodies logic to interface with a smart contract.

13. The method of claim 12, wherein the smart contract is a smart contract of a Decentralized Autonomous Organization.

14. A system to generate and execute a workflow, comprising:
a processor;
a computer readable memory;
a data store storing rules relating to workflow, jurisdiction data, standards data, and regulations data; and
a workflow generator software component resident in the memory communicatively coupled with the data store and configured to generate a dynamic workflow embodied in a wizard comprised of a succession of screens, the screens implementing rules to drive the creation of documents compliant with the accessed jurisdiction data, standards data, and regulations data, such that a user of the wizard cannot deviate from the underlying workflow.

15. The system of claim 15, comprising: a workflow engine software component resident in the memory configured to execute the wizard.

16. The system of claim 15, comprising a document generator software component resident in the memory, configured to generate a document based at least on one of the succession of screens of the wizard.

17. The system of claim 15, comprising a user interface software resident in the memory, configured to display at least one of the succession of screens of the wizard.

18. The method of claim 17, wherein at least one of the succession of screens of the wizard embodies logic to access information in any one of a digital wallet, escrow wallet, or token wallet.

19. The method of claim 18, wherein at least one of the succession of screens of the wizard embodies logic to interface with a smart contract.

20. A method to generate and execute a workflow for the preparation of financial instruments, the method comprising:
accessing at a workflow generator, a data store, the data store storing rules relating to workflow, financial jurisdiction data, financial standards data, and financial regulations data;
based on at least the accessed rules, generating by the workflow generator a dynamic workflow embodied in a wizard comprised of a succession of screens, the screens implementing rules to drive the creation of documents compliant with the accessed financial jurisdiction data, financial standards data, and financial regulations data, such that a user of the wizard cannot deviate from the underlying workflow;
receiving a change to one or more of the financial jurisdiction data, financial standards data, and financial regulations data;
responsive to receiving the change, dynamically changing the workflow, and the wizard to reflect the received change; and
wherein at least one of the succession of screens of the wizard embodies logic to generate a financial document, receive an electronic signature for the financial document, and to store the financial document in a data room.
